(19) United States
(12) Patent Application Publication
(10) Pub. No.: US 2026/0346592 A1
(43) Pub. Date: Nov. 5, 2026

(54) POLYETHYLENE TEREPHTHALATE LAMINATE

(71) Applicant: Aquafigure AS, Stavanger (NO)

(72) Inventors: Orjan Tunge Asbjornsen, Stavanger (NO); Kyrre Delin Fredriksen, Stavanger (NO)

(21) Appl. No.: 19/487,216

(22) PCT Filed: May 23, 2024
(86) PCT No.: PCT/EP2024/064296

§ 371 Date: Nov. 24, 2025

Related U.S. Application Data
(60) Provisional application No. 63/504,315, filed on May 25, 2023.

(51) Int. Cl. B32B 27/36; B32B 27/08; C08J 5/12; C08L 67/02

(52) U.S. Cl. CPC B32B 27/36; B32B 27/08; C08J 5/121; C08L 67/02; B32B 2250/02; B32B 2250/244; B32B 2307/518; B32B 2307/702; C08J 2367/02; C08L 2205/025

(57) ABSTRACT

Disclosed is a laminate including a first amorphous polyethylene terephthalate (APET) film layer coextruded with a first biaxially-oriented polyethylene terephthalate (BOPET) layer; a polyester-based dry toner layer applied to a portion of the surface of the APET film layer; and a second APET layer coextruded with a second BOPET layer, the surface of the second APET layer applied to, and heat sealed to the surface of the first APET layer having the applied dry toner layer thereon, wherein the dry toner layer is encapsulated by the heat sealed APET layers.

### CROSS-REFERENCE TO RELATED APPLICATIONS

This application claims priority to U.S. Provisional Patent Application No. 63/504,315, filed May 25, 2023. The contents of this application are incorporated herein by reference in its entirety.

### TECHNICAL FIELD

This disclosure relates to a bi-laminate of polyethylene terephthalate encompassing graphics, the laminate is intended for display as an insert with printed indicia or artwork within a bottle or other container and in contact with a liquid. More particularly, the disclosure relates to a laminate of polyethylene terephthalate (PET), biaxially-oriented polyethylene terephthalate (BOPET), or amorphous polyethylene terephthalate (APET), intended for display within a bottle or other container and in contact with a liquid.

### BACKGROUND

Containers with a removable, self-supported insert (or “foil”) for placement within the container are described in U.S. Pat. No. 10,370,138 (the '138 patent; hereby incorporated in its entirety herein by reference). In particular, the '138 patent discloses, inter alia, a plastic beverage container (e.g., a bottle), having a body, a neck and a reduced diameter opening (or mouth) with a fitting for a closure or cap. An insert is provided which can be reversibly placed within the container. The insert should be sufficiently flexible so as to be reversibly deformed and placed into or removed from the container through the mouth, e.g., by rolling the substantially planar insert into a roll having a diameter less than a diameter of the mouth of the container.

The insert may be provided with printed graphics or indicia for display within the beverage container, through the transparent or translucent liquid contained therein, and through the transparent or translucent walls of the container, such that a user can view the graphics and/or indicia of the insert while the insert is contained within the beverage container containing a preferably translucent or transparent liquid, e.g., water.

Since it is contemplated that the insert will be in contact with a liquid for all or part of the time it is placed within the beverage container, and that the liquid may be ingested by a user, it is important that the finished insert meet safety requirements for food contact surfaces, such as contact with both aqueous and non-aqueous liquid foodstuffs, including water, alcohol, liquids having an acidic or basic pH and oil-based liquids.

Since it is also contemplated that the insert may be employed as a removable collectible device or promotional item, the insert should also be compatible with washing in a residential dishwasher, and also able to withstand bending, folding and mutilation without tearing or breaking into pieces.

### SUMMARY

In one instance, a laminate includes a first APET film layer coextruded with a first PET layer; a polyester-based dry toner layer applied to a portion of the surface of the APET film layer; a second APET layer coextruded with a second PET layer, the surface of the second APET layer applied to and heat sealed to the surface of the first APET layer having the applied dry toner layer thereon, wherein the dry toner layer is encapsulated by the heat sealed APET layers. The purpose of the APET layers is to act as both a heat seal and as a pre-treat or anchor for the toner.

In one instance, a laminate includes a APET layer having an upper and lower surface and encapsulating a fused dry toner layer; and a first BOPET layer bonded to the upper surface of the APET layer; and a second BOPET layer bonded to the lower surface of the APET layer.

In one instance, a method of making a laminate, includes the steps of providing a first APET layer coextruded with a first BOPET layer; applying a polyester-based dry toner layer to at least a portion of the surface of the first APET film layer; fusing the polyester-based dry toner layer; providing a second APET layer coextruded with a second BOPET layer and applying the surface of the second APET layer to the surface of the first APET film layer bearing the fused dry toner layer with heat and pressure, thereby forming a laminate wherein the first and second APET film layers are heat sealed together and the fused dry toner layer is encapsulated.

In one instance, the fused dry toner layer forms a printed image.

In one instance, the dry toner layer provides printed artwork.

In one instance, the laminate is an insert for a beverage container.

In one instance, each PET layer is between 150 and 200 micrometers in thickness.

In one instance, each PET layer is 165 micrometers in thickness.

In one instance, each APET layer is between 5 and 20 micrometers in thickness.

In one instance, each APET layer is 10 micrometers in thickness.

In one instance, the dry toner is fused at a temperature of between 90 and 130 degrees C.

In one instance, the dry toner is fused for between 0.05 and 0.5 seconds.

In one instance, the dry toner is fused for 0.2 seconds.

In one instance, the APET layers are heat sealed at a temperature of between 90 °C and 180 °C (and preferably between 100 °C and 140 °C), and at a pressure of between 100 and 1000 kilopascal and for a dwell time of between 0.05 and 0.2 seconds.

In one instance, the APET layers are heat sealed with a twin roll laminator with dual heating set between 100 °C and 140 °C.

In one instance, the dry toner is applied by electrophotographic printer.

In one instance, the laminate is cut to provide an insert.

In one instance, the laminate is cut by a die cutter.

In one instance, the die cutter is a rotary die cutter.

In one instance, the die cutter is a flatbed die cutter.

In one instance, the laminate is cut by laser.

In one instance, the laminate is cut by waterjet.

In one instance, a clearance is provided between the edge of the fused dry toner layer and the edge of the insert.

In one instance, the clearance is 5 mm.

In one instance, the clearance is 2 mm.

In one instance, the BOPET includes at least 30% post-consumer recycled material.

In one instance, the insert is a decorative container insert.

In one instance, a laminate includes a first APET film layer coextruded with a first PET layer; a polyester-based dry toner layer applied to a portion of the surface of the APET film layer; a second APET layer coextruded with a second PET layer, the surface of the second APET layer applied to, and heat sealed to the surface of the first APET layer having the applied dry toner layer thereon, wherein the dry toner layer is encapsulated by the heat sealed APET layers.

In one instance, a laminate includes a APET layer having an upper and lower surface and encapsulating a fused dry toner layer; and a first PET layer bonded to the upper surface of the APET layer; and a second PET layer bonded to the lower surface of the APET layer.

In one instance, a method of making a laminate includes providing a first APET layer coextruded with a first PET layer; applying a polyester-based dry toner layer to at least a portion of the surface of the first APET film layer; fusing the polyester-based dry toner layer; providing a second APET layer coextruded with a second PET layer and applying the surface of the second APET layer to the surface of the first APET film layer bearing the fused dry toner layer with heat and pressure, thereby forming a laminate wherein the first and second APET film layers are heat sealed together and the fused dry toner layer is encapsulated.

In one instance, a laminate includes a first APET film layer coextruded with a first BOPET layer; a printing ink layer applied to a portion of the surface of the APET film layer;
a second APET layer coextruded with a second BOPET layer, the surface of the second APET layer applied to, and heat sealed to the surface of the first APET layer having the applied ink layer thereon, wherein the printing ink layer is encapsulated by the heat sealed APET layers.

In one instance, a laminate includes a APET layer having an upper and lower surface and encapsulating a printing ink layer; and a first BOPET layer bonded to the upper surface of the APET layer; and a second BOPET layer bonded to the lower surface of the APET layer.

In one instance, a method of making a laminate, includes providing a first APET layer coextruded with a first BOPET layer; applying a printing ink layer to at least a portion of the surface of the first APET film layer; curing the printing ink layer; providing a second APET layer coextruded with a second BOPET layer and applying the surface of the second APET layer to the surface of the first APET film layer bearing the cured printing ink layer with heat and pressure, thereby forming a laminate wherein the first and second APET film layers are heat sealed together and the cured printing ink layer is encapsulated.

In one instance the printing ink is selected from the group consisting of aqueous and solvent base flexo-and roto-gravure inks.

### BRIEF DESCRIPTION OF THE FIGURES

FIG. 1 illustrates a cross section of a plastic film used to manufacture the insert. The film includes a layer of clear BOPET film (2) with a co-extruded APET heat seal layer (1).

FIG. 2 shows a cross section of a layer of print (3) being applied to the surface of the heat-sealable layer of the film. The print includes a polyester-based dry toner.

FIG. 3 illustrates a cross section of the printed film being over-laminated with the same film (4) as shown in FIG. 1, where the heat sealable layer is facing the heat sealable layer of the printed film. The print is placed within the boundaries of the film's edges to ensure full encapsulation. The over-laminating film can also have a different thickness than the printed film.

FIG. 4 illustrates the thermal lamination, where heat and pressure are employed to activate the APET heat seal layers.

FIG. 5 illustrates a cross section of the finished insert, where the two heat seal layers are bonded, thus creating mono-material (polyester) insert with encapsulated print.

FIG. 6 illustrates a top view of a finished insert, showing the print fully encapsulated by the heat seal layers and within the boundaries of the film edges.

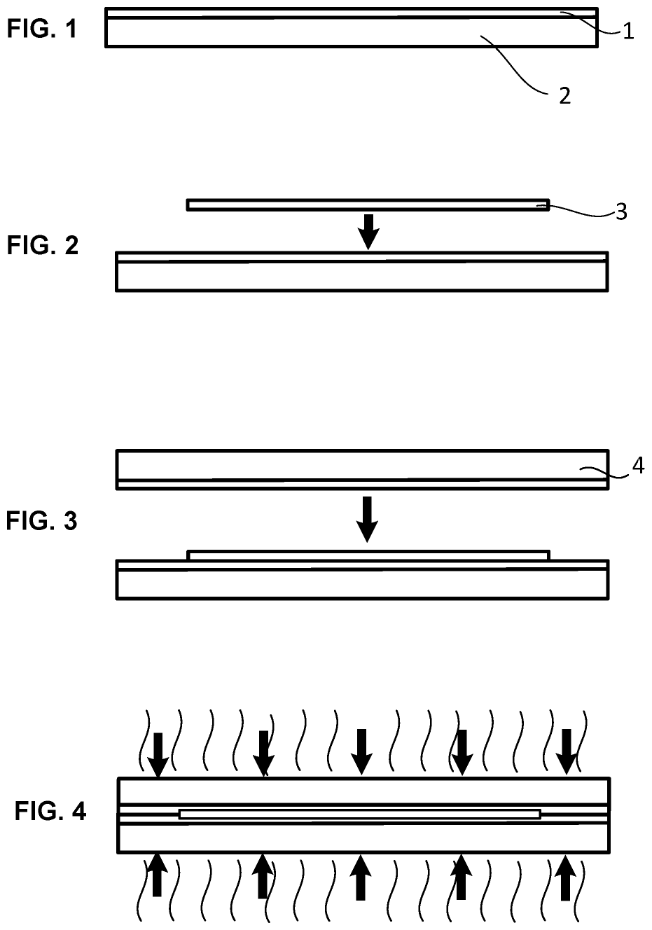

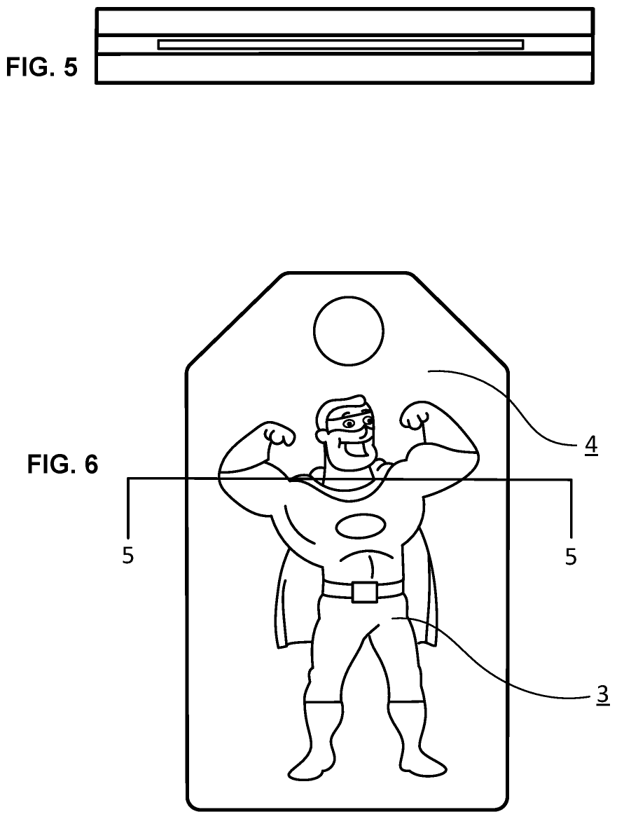

### DETAILED DESCRIPTION

The required flexibility and robustness of the display insert, in addition to the need for compliance with directives of both the EU and FDA regarding direct food contact for all food and drink types, dictates that the insert should be made from an inert polymeric material which henceforth will be referred to under its generic name “plastic”.

The plastic material should have excellent thermal and chemical resistance (particularly hydrolysis resistance), as well as high durability and superb optical qualities (low haze). The material must also comply with direct food contact requirements described in, for example, European Standard EN 1186 (“Materials and articles in contact with foodstuffs—Plastics”). Examples of such materials are polyester-based plastics, such as cast PET (Polyethylene Terephthalate), sheet APET (Amorphous Polyethylene Terephthalate), co-polyester of PET and BOPET (biaxially-oriented Polyethylene Terephthalate).

While PET films themselves may be able to satisfy food contact regulations, the printed artwork (e.g., graphics, images and/or text) applied to the insert is a potential contamination/migration source when the insert is immersed in a beverage and should therefore be encapsulated and isolated to ensure direct food contact regulatory compliance. To minimize the risk of migration any inks, chemicals and/or adhesives should be food contact compliant (with all aqueous and non-aqueous liquid food stuffs) or even avoided altogether.

Solvent-based printing inks and lamination adhesives are sources of potential migration, which could result in contamination of the liquid when the insert is immersed in a container containing a beverage. Additionally, they have the potential to cause delamination of the insert itself due to hydrolysis or other degradation as the result of prolonged exposure to aqueous, alcoholic, acidic and oil-based food stuffs (all types).

A printed and adhesively laminated plastic insert will typically not be compatible with PET recycling, due to the use of multiple plastic types, printing chemicals and adhesives.

Thermally activated lamination films (such as EVA-ethylene vinyl-acetate) are typically laminated to non-heat activated plastic films. Such films have been tested for the application in question but provide insufficient lamination strength (“peel initiation strength”). Further, while EVA to EVA lamination might increase the peel strength of the laminate, such a laminate exhibits unacceptable levels of haze.

Examples of plastic materials suitable for manufacturing the insert are heat-sealable polyester films used in the food packaging industry, for example “Hostaphan®” film from Mitsubishi Polyester Film or “Mylar®” from DuPont Teijin Films. Such films are however typically manufactured with less thickness (12-36 micrometers) than the preferred film thickness (75-300 micrometers) for an embodiment of the present bottle insert. Two 175 micrometer thick films are used in an embodiment of the insert, resulting in a finished laminated insert with a thickness of 350 micrometers. In an embodiment, the 175-micrometer film is made from BOPET (160 micrometers) with a coextruded heat seal layer of APET having a thickness of between 5 and 25 micrometers, and preferably 15-21 micrometers, and more preferably 19-21 micrometers. The APET heat seal layer forms its bond through a diffusion process. Once the material is heated above its glass transition temperature (typically 50-90 °C), inter-molecular diffusion between the two contacting layers results in a permanent bond. If the dwell time is too short or the temperature is too low, it results in a “tack seal” (non-permanent bond. This temperature (often called activation temperature) occurs over the temperature range of 90 to 200 °C and time at temperature in the range of 0.01 to 5 seconds. The co-polyester heat seal chemistry produces a permanent seal, differentiated from a peelable seal which will delaminate uniformly if subjected to a force. The co-polyester layer seal produces a bond strength in the range 1000-3000 g/25 mm. ASTM D1876 can be used to determine bond strength/peel resistance.

The co-polyester layer is preferably between 1-20% of the total thickness of the insert.

The printed artwork for the insert is applied using an electrophotographic printer, with polyester based dry toner. Polyester based dry toner is made from polyester granules containing color pigments, which are then ground to a fine powder. The thickness of the applied print is typically between 1 and 3 micrometers, but can range from 0.1 to 30 micrometers, depending on colors, color saturation and whether the print is done in one or two passes. The co-polyester heat-sealing surface is compatible with multiple types of printing inks, including dry toner, aqueous, and solvent base flexo-and roto-gravure types.

Since the artwork should be visible from both sides of the insert, the print is ideally applied using two color layers with a layer of opaque white in between: First, the image is printed using four colors (cyan, magenta, yellow, black (CMYK)) followed by a covering layer of opaque white. The image is then printed again with CMYK colors on top of the opaque white. The artwork will typically appear translucent in areas where the opaque white is absent, something that can intentionally be used as a visual effect.

To achieve a non-translucent printed image that is visible from both sides of the insert, a printer with nine color stations is preferred (CMYK+white+CMYK), although 7 colors will also work (CMY+white+CMY) since black color can be achieved by mixing cyan, magenta and yellow. Alternatively, a printer with four to six color stations can be used, but the film will then need to be printed twice. Other colors than CMYK (for example fluorescent, metallic, thermochromic, glow-in-the-dark, photochromic, UV-activated) can be used for special visual effects. Suppliers of relevant dry toner printers include, but are not limited to Kodak, Konica Minolta, Xerox, Xeikon and FujiFilm.

After being applied to the film material, the dry toner is fused using a heated cylinder. Adherence of the toner to the heat seal layer is by diffusion, but the contact time is so short (<0.2 seconds) and at such a low temperature (<130 °C) that the heat seal layer is not activated. In addition, any unwanted surface crystallization which would compromise any subsequent lamination is also avoided.

A flatbed laminator or a roll-to-roll laminator can be used for thermal lamination of the printed film. Since the heat seal component is made from a co-polyester (APET) there is the possibility that prolonged exposure to heat (>90 °C) can cause crystallization in the material, which will again increase haze (resulting in decreased transparency). It is therefore desirable to activate the heat seal layers in both films as efficiently as possible. In an embodiment, this can be achieved using dual side heating in the laminator. In an embodiment, a roll laminator with dual heating set between 100 °C and 140 °C is used. The lamination pressure is set between 100 and 1000 kilopascal. The dwell time for the lamination is set for between 0.05 and 1 second, preferably between 0.05 and 0.2 seconds.

After thermal lamination, the film is cut to a desired insert shape using for example, a die cutter. Both rotary and flatbed die cutting can be used. Alternative suitable methods include laser cutting and waterjet cutting. To ensure sufficient encapsulation of printed artwork and thus compliance with food contact regulations, a clearance should be maintained between the printed artwork and the die cut edge. In an embodiment, the clearance can be between 0.1 and 10 mm, more preferably 1, 2, 3, 4 or 5 mm between the edge of the printed artwork and the die cut edge.

An embodiment of the current insert has been tested according to EN 1186—“Materials and articles in contact with foodstuffs—Plastics” and found to be compliant with “Commission Regulation (EU) No 10/2011 of 14.01.2011 on plastic materials and articles intended to come into contact with food” and Regulation (EC) No 1935/2004 Article 3 section 1 paragraphs a) and b).

In an embodiment, an insert of the present disclosure includes a self-supported display insert (foil) with the following properties:
Mono-material construction (using for example, PET, including co-extruded biaxially orientated polyester film (BOPET).
Co-polyester heat-sealing surface with additional compatibility with all types of printing inks (dry toner, aqueous, and solvent base flexo- and roto-gravure types).
High thermal resistance (<1% longitudinal and transverse shrinkage at 150 °C, and thermal stability with processing temperatures up to 230 °C. Testing according to ASTM-D1204).
Robustness (>80% elongation at break, yield stress >90 MPa, tensile strength >160 MPa, >1000 g peel initiation strength (90° peel test, 25 mm sample width)). (Tensile testing according to ASTM-D882.)
Flexible and robust—the insert withstands being curled to a longitudinal cylinder with a diameter equal to the insert width divided by Pi, without permanent deformation (because of high yield stress) or delamination.
Insertion recovery—the insert must fully recover to its original shape when inserted into a beverage container through the container mouth of reduced diameter. The insert's recovery properties are in part due to the high tensile modulus of the film (3-5 GPa).
The insert exhibits excellent transparency and optical qualities (haze <3% for single film or web; 5-6 % when laminated and a total luminous transmission (TLT) for the laminated insert of >85% (typically 86-90%)), even when using a minimum of 30% PCR (Post-Consumer Recycled) material. (Haze measurements according to ASTM-D1003.)
Child safe—the laminated insert must not tear, break, or delaminate. An embodiment has been tested to 25,000 torsional and bending flexes without any signs of fatigue cracking. Torsional flex measured as angular from corner to corner −30 degrees deflection at 30 flexes per minute (one edge of insert remains static but bends the opposite edge through +/−30 degrees). Longitudinal flex measured along long axis of insert −2 cm deflection at 30 flexes per minute; and latitudinal flex measured along short axis of insert −1 cm deflection at 30 flexes per minute.

In an embodiment, the insert provides a superior food contact standard, achieved using food contact approved polyesters, and polyester based dry toner inks.

In an embodiment, the insert shows compatibility between the polyester based dry toner inks and the heat sealable co-extruded side of the PET film. The ink transfer process is direct from the impression drum and does not require additional release aids such as silicone oils.

In an embodiment, the insert exhibits superior interlaminate bond strength between the laminated films and encapsulated printed graphics by thermally laminating the printed surface to an identical co-extruded polyester film, where the heat sealable sides (amorphous co-polyester) are oriented against each other.

In an embodiment, a mono-material structure is provided in the insert by using polyester-based materials in toner, film and heat seal, which means the insert can be sorted and recycled as PET (recycling can be either mechanical or chemical depolymerization). The polyester-based dry toner also ensures superb laminate bonding in the printed areas against the amorphous co-polyester.

In an embodiment, the insert provides printing with polyester dry toner onto the amorphous heat sealable co-polyester side of a co-extruded biaxially-oriented polyester film without the use of a non-stick medium (“release agent”). Polyester based dry toner printing normally employs a non-stick medium on the heated cylinder that fuses the polyester toner after printing. By printing without a release agent, stronger lamination bonding is achieved, albeit perhaps at the cost of the longevity of the heated cylinder.

In an embodiment, the co-extruded polyester film is manufactured using a minimum of 30% mechanically recycled PCR material. The film can be made from as much as 100% mechanically recycled PCR, but doing so may reduce the optical qualities of the laminate. Chemically recycled PCR (when available) will enable manufacturing the film from 100% PCR without reducing its optical qualities, but chemically recycled PCR presently has limited commercial availability. This is expected to change within the next few years.

In an embodiment, instead of or in addition to ink, metallic images can be substituted for the printed graphics and applied through metal transfer foils and direct metallization/de-metallization techniques.

In an embodiment, the present insert is provided as a mono-material in a laminated plastic insert with printed graphics, by using co-extruded biaxially orientated polyester film (with a PCR content in the range of 0-100%), polyester dry toner and co-polyester heat seal chemistries.

In an embodiment, the printed artwork is encapsulated with a co-extruded biaxially orientated polyester film, where the co-extruded amorphous heat sealable co-polyester side of the laminating film is facing the co-extruded amorphous heat sealable co-polyester side of the printed film, thus achieving superb bonding strength between laminated films regardless of printed surfaces and without the use of additional adhesives or solvents.

In an embodiment, the PET film is a primary biaxially orientated BOPET layer with a crystallinity in the range 30 to 50%. The crystallinity level can be quantified by for example performing differential scanning calorimetry (DCS) where heat flow into or from a heated or cooled test sample is measured.

In an embodiment, an insert is prepared having a first and second BOPET layer each having a thickness of ~155 micrometers, with a coextruded APET layer of ~20 micrometers. The thickness of the print heat sealed between the two layers is between 8 and 30 micrometers, depending on colors, color saturation and whether the print is done in one or two passes. This provides an overall insert thickness of ~350 micrometers, but with a thickness of ~358-380 micrometers in the printed areas.

1. A laminate, comprising:
a first APET film layer coextruded with a first BOPET layer; a polyester-based dry toner layer applied to a portion of the surface of the APET film layer;
a second APET layer coextruded with a second BOPET layer, the surface of the second APET layer applied to, and heat sealed to the surface of the first APET layer having the applied dry toner layer thereon, wherein the dry toner layer is encapsulated by the heat sealed APET layers.

2. A laminate, comprising:
a APET layer having an upper and lower surface and encapsulating a fused dry toner layer; and
a first BOPET layer bonded to the upper surface of the APET layer; and
a second BOPET layer bonded to the lower surface of the APET layer.

3. A method of making a laminate, comprising
providing a first APET layer coextruded with a first BOPET layer;
applying a polyester-based dry toner layer to at least a portion of the surface of the first APET film layer;
fusing the polyester-based dry toner layer;
providing a second APET layer coextruded with a second BOPET layer and applying the surface of the second APET layer to the surface of the first APET film layer bearing the fused dry toner layer with heat and pressure, thereby forming a laminate wherein the first and second APET film layers are heat sealed together and the fused dry toner layer is encapsulated.

4. The method of claim 3, wherein the fused dry toner layer forms a printed image.

5. The method of claim 3, wherein the dry toner layer provides printed artwork.

6. The method of claim 3, wherein the laminate is an insert for a beverage container.

7. The method of claim 3, wherein each BOPET layer is between 150 and 200 micrometers in thickness.

8. The method of claim 7, wherein each BOPET layer is 165 micrometers in thickness.

9. The method of claim 3, wherein each APET layer is between 5 and 20 micrometers in thickness.

10. The method of claim 9, wherein each APET layer is 10 micrometers in thickness.

11. The method of claim 3, wherein the dry toner is fused at a temperature of between 90 and 130 degrees C.

12. The method of claim 11, wherein the dry toner is fused for between 0.05 and 0.5 seconds.

13. The method of claim 12, wherein the dry toner is fused for 0.2 seconds.

14. The method of claim 3, wherein the APET layers are heat sealed at a temperature of between 100 °C and 140 °C, and at a pressure of between 100 and 1000 kilopascal and for a dwell time of between 0.05 and 0.2 seconds.

15. The method of claim 14, wherein the APET layers are heat sealed with a roll laminator with dual heating set between 100 °C and 140 °C.

16. The method of claim 3, wherein the dry toner is applied by electrophotographic printer.

17. The method of claim 3, wherein the laminate is cut to provide an insert.

18. The method of claim 17, wherein the laminate is cut by a die cutter.

19. The method of claim 18, wherein the die cutter is a rotary die cutter.

20. The method of claim 18, wherein the die cutter is a flatbed die cutter.

21. The method of claim 17, wherein the laminate is cut by laser.

22. The method of claim 17, wherein the laminate is cut by waterjet.

23. The method of claim 17, wherein a clearance is provided between the edge of the fused dry toner layer and the edge of the insert.

24. The method of claim 23, wherein the clearance is 5 mm.

25. The method of claim 23, wherein the clearance is 2 mm.

26. The method of claim 3, wherein the PET includes at least 30% post-consumer recycled material.

27. The method of claim 3, wherein the laminate is a decorative container insert.

28. A laminate, comprising:
a first APET film layer coextruded with a first PET layer;
a polyester-based dry toner layer applied to a portion of the surface of the APET film layer;
a second APET layer coextruded with a second PET layer, the surface of the second APET layer applied to, and heat sealed to the surface of the first APET layer having the applied dry toner layer thereon, wherein the dry toner layer is encapsulated by the heat sealed APET layers.

29. A laminate, comprising:
a APET layer having an upper and lower surface and encapsulating a fused dry toner layer; and
a first PET layer bonded to the upper surface of the APET layer; and
a second PET layer bonded to the lower surface of the APET layer.

30. A method of making a laminate, comprising
providing a first APET layer coextruded with a first PET layer;
applying a polyester-based dry toner layer to at least a portion of the surface of the first APET film layer;
fusing the polyester-based dry toner layer;
providing a second APET layer coextruded with a second PET layer and applying the surface of the second APET layer to the surface of the first APET film layer bearing the fused dry toner layer with heat and pressure, thereby forming a laminate wherein the first and second APET film layers are heat sealed together and the fused dry toner layer is encapsulated.

31. A laminate, comprising:
a first APET film layer coextruded with a first BOPET layer;
a printing ink layer applied to a portion of the surface of the APET film layer;
a second APET layer coextruded with a second BOPET layer, the surface of the second APET layer applied to, and heat sealed to the surface of the first APET layer having the applied printing ink layer thereon, wherein the printing ink layer is encapsulated by the heat sealed APET layers.

32. A laminate, comprising:
a APET layer having an upper and lower surface and encapsulating a printing ink layer; and
a first BOPET layer bonded to the upper surface of the APET layer; and
a second BOPET layer bonded to the lower surface of the APET layer.

33. A method of making a laminate, comprising
providing a first APET layer coextruded with a first BOPET layer;
applying a printing ink layer to at least a portion of the surface of the first APET film layer;
curing the printing ink layer;
providing a second APET layer coextruded with a second BOPET layer and applying the surface of the second APET layer to the surface of the first APET film layer bearing the cured printing ink layer with heat and pressure, thereby forming a laminate wherein the first and second APET film layers are heat sealed together and the cured printing ink layer is encapsulated.

34. The laminate of claim 31 or 32, wherein the printing ink is selected from the group consisting of aqueous and solvent base flexo-and roto-gravure inks.

35. The method of claim 33 wherein the printing ink is selected from the group consisting of aqueous and solvent base flexo- and roto-gravure inks.
